(19) United States
(12) Patent Application Publication
(10) Pub. No.: US 2023/0005000 A1
(43) Pub. Date: Jan. 5, 2023

(54) IDENTIFYING COMMERCIALIZATION OPPORTUNITY FOR A DIGITAL TWIN ARTIFACT CAPTURED ON A MOBILE DEVICE

(71) Applicant: INTERNATIONAL BUSINESS MACHINES CORPORATION, ARMONK, NY (US)

(72) Inventors: Lisa Seacat DeLuca, Bozeman, MT (US); Jonathan Tristan O'Gorman, Whitegate (IE)

(21) Appl. No.: 17/305,075

(22) Filed: Jun. 30, 2021

(51) Int. Cl. G06Q 30/02; G06Q 30/06; G06T 17/00

(52) U.S. Cl. CPC G06Q 30/0206; G06Q 30/0643; G06T 17/00; G06T 2200/08

(57) ABSTRACT

According to one embodiment, a method, computer system, and computer program product for identifying commercialization opportunities for digital twin resources captured on a sensor is provided. The present invention may include receiving digital content pertaining to a physical asset captured by the sensor; responsive to determining that no digital twin resources within a digital twin content store associated with the physical asset exceed a threshold level of similarity to the digital content, uploading the digital content to the digital twin content store based on a user response to one or more prompts.

### BACKGROUND

The present invention relates, generally, to the field of computing, and more particularly to digital twin creation and maintenance.

A digital twin is a virtual representation of a physical object which is maintained and updated regularly using sensor data and human observation such that the virtual object is an up-to-date and accurate copy of its physical counterpart; the virtual object can therefore be accessed to ascertain the properties and states of the corresponding physical asset at any given moment in time, making the digital twin concept extremely useful in product design, asset maintenance, asset monitoring, diagnostics, et cetera. The digital twin may be used for any number of industry applications including but not limited to HVAC systems, automated installations, locomotives, buildings, utilities, aircraft engines, and wind turbines.

### SUMMARY

According to one embodiment, a method, computer system, and computer program product for identifying commercialization opportunities for digital twin resources captured on a sensor is provided. The present invention may include receiving digital content pertaining to a physical asset captured by the sensor; responsive to determining that no digital twin resources within a digital twin content store associated with the physical asset exceed a threshold level of similarity to the digital content, uploading the digital content to the digital twin content store based on a user response to one or more prompts.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a digital twin commercialization process according to at least one embodiment;

FIG. 3 illustrates a graphical user interface associated with the digital twin commercialization process according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to digital twin creation and maintenance. The following described exemplary embodiments provide a system, method, and program product to, among other things, identify commercialization opportunities for digital twin artifacts captured on a mobile device. Therefore, the present embodiment has the capacity to improve the technical field of digital twin creation and maintenance by providing an enhanced method of identifying gaps where a digital twin lacks content pertaining to a physical asset, alerting a user that digital content created by the user could fill the gap in content pertaining to the physical asset, and provide prompting and commercial incentives for the user to upload the content to a digital twin content store, thereby adding to the body of resources comprising the digital twin and improving the fidelity, accuracy, and completeness of the digital twin.

As previously described, a digital twin is a virtual representation of a physical object which is maintained and updated regularly using sensor data and human observation such that the virtual object is an up-to-date and accurate copy of its physical counterpart; the virtual object can therefore be accessed to ascertain the properties and states of the corresponding physical asset at any given moment in time, making the digital twin concept extremely useful in product design, asset maintenance, asset monitoring, diagnostics, et cetera. Digital twin content stores, such as the IBM Digital Twin Exchange, allow manufacturers to provide digital resources to owners and operators of their assets. These digital resources help companies more intelligently operate their business. However, often times companies are not aware that their teams generate digital twin resources that could be commercialized and made available for sale on a digital twin exchange. Often, these digital twin resources are created in the field by technicians and used solely by the organization within an Enterprise Asset Management (EAM) tool like IBM Maximo. What is needed is a way to highlight to technicians that the digital content they are creating might be possible to make available on a digital twin exchange to generate revenue for their organizations.

According to one embodiment, the invention is a system and method to cross reference available digital twin resources within a digital twin content store with digital content pertaining to the physical asset captured by a technician in the field to determine revenue potential and resource opportunities for content publication.

The physical asset, as referred to herein, may be a physical object represented virtually by a digital twin, which may be a virtual facsimile of the physical object. The physical asset may be any machine, device, object, system, et cetera, so long as it is tangible and physical, such as a vehicle, industrial equipment, sensor installation, architectural element, et cetera. In some embodiments, a digital twin may represent an entire class of similar physical assets, such as a production model truck, a certain model of washing machines, et cetera, and the term ‘physical asset’ may herein be referring to the class of similar physical assets.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to identify commercialization opportunities for digital twin artifacts captured on a mobile device.

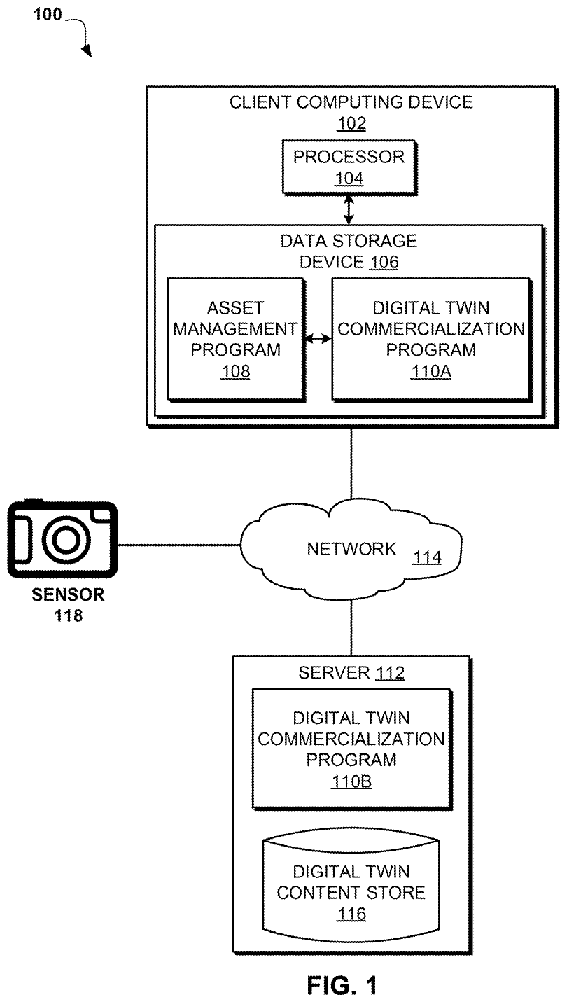

Referring to FIG. 1, an exemplary networked computer environment 100 is depicted, according to at least one embodiment. The networked computer environment 100 may include client computing device 102, a server 112, and a sensor 118 interconnected via a communication network 114. According to at least one implementation, the networked computer environment 100 may include a plurality of client computing devices 102, servers 112, and sensors 118, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

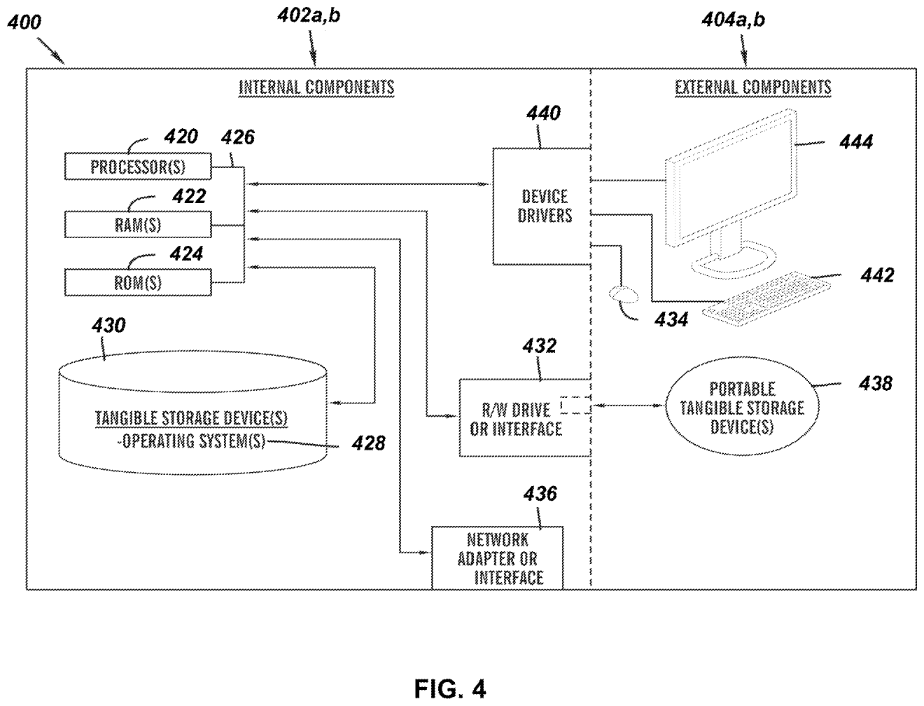

Client computing device 102 may include a processor 104 and a data storage device 106 that is enabled to host and run an asset management program 108 and a digital twin commercialization program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a digital twin commercialization program 110B and a digital twin content store 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

The asset management program 108 may be a software program used to maintain and control operational assets and equipment which is capable of populating and displaying lists of work orders pertaining to physical assets. Work orders may be instructions to perform some task associated with the physical asset, and may be visible and/or selectable to one or more users or classes of users such as field technicians, back office employees such as work planners, asset managers, or supervisors, individuals who are part of an organization that owns the physical asset, and/or the company who is dispatching or contracting support for the physical asset, based on, for example, the nature of the task to be performed, the skills of the user or class of user, and/or the assignment procedure of the work order. Work orders may comprise a description and/or information regarding the task to be performed and an identification of the physical asset (identification number, asset title, et cetera) or a plurality of details describing the physical asset (location, make, model, type of device, class of device, et cetera) upon which the task is to be performed. An example of an asset management program 108 may include IBM® Maximo® Mobile (Maximo® and all Maximo®-based trademarks and logos are trademarks or registered trademarks of International Business Machines Corporation, and/or its affiliates), which is capable of using real-time data and operational history to generate digital twin content based on an analysis of similar digital twin resources. Asset management program 108 may be located on client computing device 102, server 112, or any other device located within or in communication with network 114. Furthermore, the asset management program 108 may be distributed in its operation over multiple devices, such as client computing device 102 and server 112.

The digital twin content store 116 may be a digital repository and/or marketplace such as the IBM® Digital Twin Exchange (IBM® and all IBM®-based trademarks and logos are trademarks or registered trademarks of International Business Machines Corporation, and/or its affiliates) where digital twin resources associated with a physical asset are aggregated and offered for sale. Digital twin resources may be resources associated with a physical asset that facilitate the creation and maintenance of a digital twin corresponding with that physical asset. For example, digital twin resources may include manuals, bills of material, parts, manufacture date or age of the physical asset, modernization/refurbishment date of the physical asset, manufacturing warranty notifications, warranty claims, insurance claims, insurers, insurance policies, maintenance plans, maintenance history, inspection history, specifications (including specifications to 3D print a part), 3D models and CAD drawings, engineering change history, fault codes, scheduled maintenance plans, operating manuals, sensor data, operating history, predictive operating models (generated for example using AI and other techniques), owner, and change in ownership. Digital twin content store 116 may be located on server 112, client computing device 102, or any other device located within or in communication with network 114. Furthermore, the digital twin content store 116 may be distributed in its operation or presence over multiple devices, such as client computing device 102 and server 112. While digital twin content store 116 is herein referred to in the singular for purposes of simplicity, one skilled in the art would understand any singular reference to digital twin content store 116 to encompass reference to any number or combination of digital twin content stores 116.

The sensor 118 may be any device capable of measuring conditions or properties of a physical asset and communicating with a digital twin commercialization program 110A, 110B, for instance via network 114. The sensor 118 may be mobile and/or may be integrated into a mobile device, such that the sensor 118 may be transported to the location of a physical asset to be measured. The sensor 118 may be integrated into the physical asset or disposed in proximity to the physical asset such that the sensor 118 is capable of measuring conditions or properties of the physical asset. Sensor 118 may be integrated into client computing device 102, for example where client computing device 102 is a mobile device, and/or may be integrated into a mobile device or other device in communication with the client computing device 102 and/or the server 112. Sensor 118 may be selected from any number of different sensors such as a visual or infrared camera, microphone, vibration sensor, et cetera. In some embodiments, the sensor 118 may comprise a global positioning system (GPS) receiver to record the location of the physical asset.

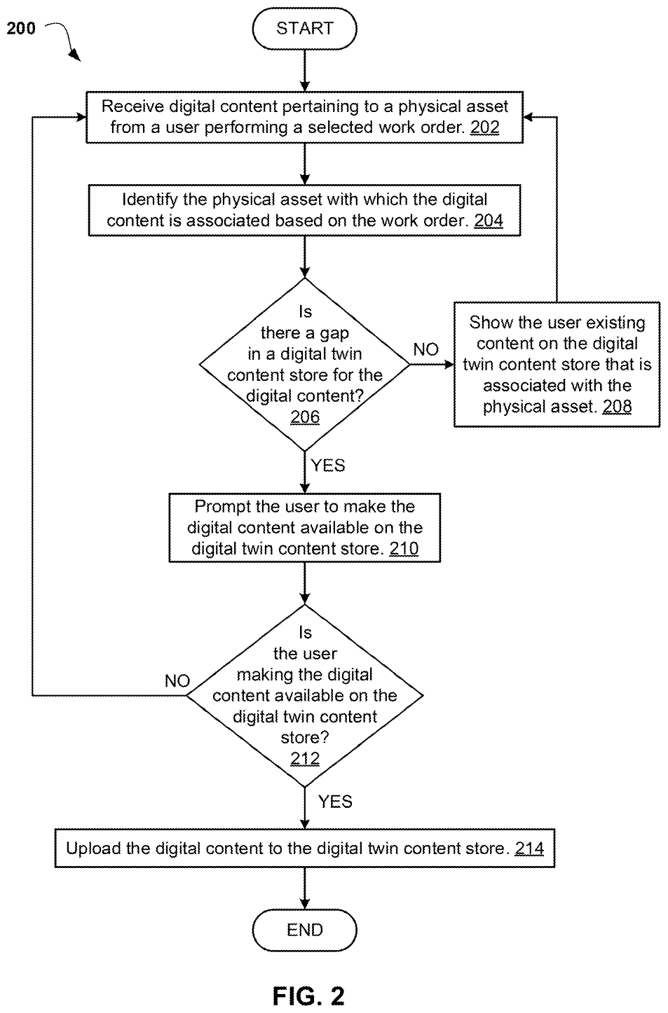

According to the present embodiment, the digital twin commercialization program 110A, 110B may be a program enabled to identify commercialization opportunities for digital twin artifacts captured on a mobile device. The digital twin commercialization program 110A, 110B may be located on client computing device 102 or server 112 or on any other device located within network 114. Furthermore, digital twin commercialization program 110A, 110B may be distributed in its operation over multiple devices, such as client computing device 102 and server 112. The digital twin commercialization method is explained in further detail below with respect to FIG. 2.

Referring now to FIG. 2, an operational flowchart illustrating a digital twin commercialization process 200 is depicted according to at least one embodiment. At 202, the digital twin commercialization program 110A, 110B receives digital content pertaining to a physical asset from a user performing a selected work order. The digital content may be any content acquired by the user via sensor 118 that is measuring some property of the physical asset and/or properties associated with some condition or state associated with the physical asset. The digital content may be recorded during or in connection with the work order. The digital content may include, for example, new imagery, for example the user may capture images of the asset such as representation of the asset in an error or failed state; acoustic evidence, such as sounds produced by the physical asset in a particular state of operation; and/or generation of new failure modes for the asset.

At 204, the digital twin commercialization program 110A, 110B identifies the physical asset with which the digital content is associated based on the work order. The digital twin commercialization program 110A, 110B may identify the physical asset to which the digital content corresponds by consulting the work order on the asset management program 108. In some embodiments, digital twin commercialization program 110A, 110B may determine contextual data for the digital content, where the contextual data is further information regarding the digital content that would assist digital twin commercialization program 110A, 110B in ascertaining whether the digital content is present within a digital twin content store 116, such as a state or condition of the physical asset at the time the digital content was ascertained. For example, contextual data could include whether digital content comprising acoustic models represent the sounds produced by the physical asset during a particular mode of operation, and/or whether the acoustic models represent the sounds produced by the physical asset that is experiencing an error state. The contextual data may be ascertained from the description of the work order, for example where the work order identifies that the physical asset is experiencing a particular error state, may be ascertained from accessible resources associated with the physical asset such as sensor data, direct communications with or from the physical asset in embodiments where the physical asset is a computing device, existing digital twin resources which may have been recently uploaded, et cetera, and/or may be ascertained from the user in response to a prompt, for example a graphical window or text field presented on a display associated with the user's client computing device 102. The contextual data may comprise metadata such as a tag or series of tags associated with the digital content providing, for example, additional description of the digital content, a class or category to which the digital content belongs (acoustic model, acoustic model during failure mode, image, video, et cetera), and/or the context within which the digital content was ascertained (for example, mode of operation such as failure mode, normal operation, low power mode, et cetera; rainy weather, poor maintenance history, et cetera). In some embodiments of the invention, the digital twin commercialization program 110A, 110B may prompt the user to confirm whether contextual data ascertained by digital twin commercialization program 110A, 110B is correct.

At 206, the digital twin commercialization program 110A, 110B determines whether there is a gap in a digital twin content store 116 for the digital content. The digital twin commercialization program 110A, 110B may search the digital twin content store 116 for all digital twin resources within the digital twin content store 116 which are associated with the identified physical asset corresponding with the digital content. The digital twin commercialization program 110A, 110B may search through each item of digital twin resources associated with the physical asset, or a subset of items of the digital twin resources associated with the physical asset such as the digital twin resources that are of the same class as the digital content, to find a match. The digital twin commercialization program 110A, 110B may identify a match if the digital content and a digital twin resource associated with the physical asset are of a similarity value that exceeds a threshold level of similarity, wherein the threshold level of similarity represents a value of similarity between a digital twin resource and the digital content above which the digital content is considered to be so similar to the digital twin resource that no commercialization opportunity exists. The threshold value may be pre-provided or determined via machine learning. The digital twin commercialization program 110A, 110B may assess similarity by assigning a similarity value to a digital twin resource based on comparing the digital twin resource with and the digital content. For example, the digital twin commercialization program 110A, 110B may compare the digital twin resource's acoustic signature to the digital content's acoustic signature, or may use image recognition to compare the digital twin resource's imagery with the digital content imagery, and assign and/or modify a similarity value. The digital twin commercialization program 110A, 110B may alternatively or additionally compare the contextual data of the digital content with the title, description, and/or contextual data of the digital twin resource to assign and/or modify similarity value.

If the level of similarity between the digital content and one or more digital twin resources associated with the physical asset exceeds the threshold value of similarity, the digital twin commercialization program 110A, 110B will determine that there is no gap in the digital twin content store 116 for the digital content, and no commercial opportunity to upload the digital content. According to one implementation, if the digital twin commercialization program 110A, 110B determines that there is not a gap in a digital twin content store for the digital content (step 206, “NO” branch), the digital twin commercialization program 110A, 110B may continue to step 208 to show the user existing content on the digital twin content store that is associated with the physical asset. However, if the level of similarity between the digital content and any of the digital twin resources associated with the physical asset fails to exceed the threshold value of similarity, the digital twin commercialization program 110A, 110B will determine that there is a gap in the digital twin content store 116 for the digital content, as well as a commercial opportunity to upload the digital content and a chance to further improve the completeness and accuracy of the digital twin. If the digital twin commercialization program 110A, 110B determines that there is a such a gap in a digital twin content store (step 206, “YES” branch), the digital twin commercialization program 110A, 110B may continue to step 210 to prompt the user to make the digital content available on the digital twin store.

At 208, the digital twin commercialization program 110A, 110B shows the user existing content on the digital twin content store that is associated with the physical asset. The digital twin commercialization program 110A, 110B may, through for example a visual window and/or text field on a display associated with the client computing device 102, display to the user one or more digital twin resources associated with the physical asset from the digital twin content store 116 to, for example, raise awareness of the user regarding what digital twin resources already exist for the physical asset and what useful digital content might look like. In some embodiments, digital twin commercialization program 110A, 110B may display a short list of similarities and/or differences between the digital content and one or more digital twin resources associated with the physical asset. For example the digital twin commercialization program 110A, 110B may display a text prompt to the user that reads as follows: “The existing model is in XML, your captured data is JSON. JSON has been downloaded 80% more by customers.” In some embodiments, the displayed digital twin resource or resources may be chosen based on their similarity values; for example, the digital twin commercialization program 110A, 110B may display any number of digital twin resources with the highest similarity values relative to the digital content. In some embodiments, the digital twin commercialization program 110A, 110B may suggest a retail price to competitively compare the digital content against existing similar digital twin resources already on the digital twin content store 116.

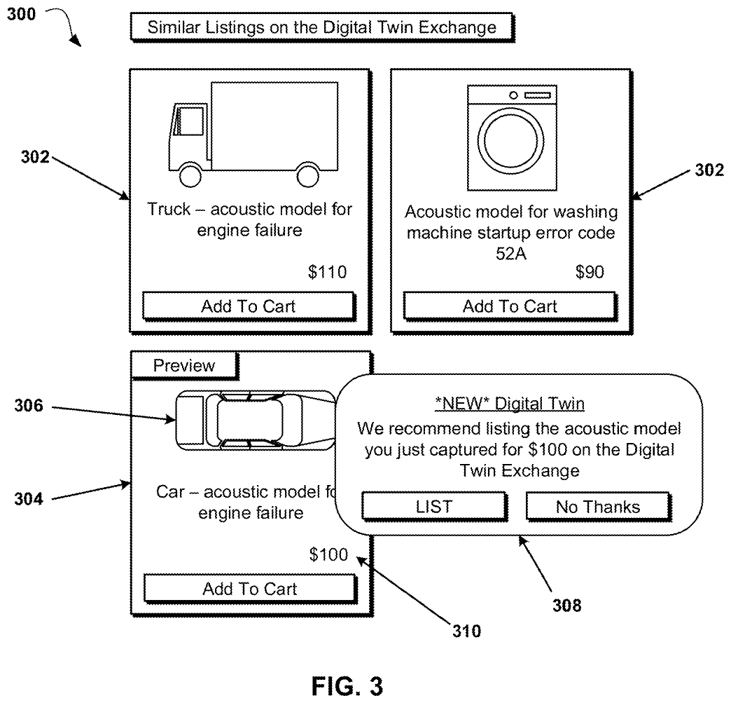

At 210, the digital twin commercialization program 110A, 110B prompts the user to make the digital content available on the digital twin content store. Here, the digital twin commercialization program 110A, 110B may display to the user a prompt indicating that the user can make the digital content available on the digital twin content store. The prompt may be discussed in further detail below with respect to element 308 of FIG. 3. In some embodiments, the digital twin commercialization program 110A, 110B may suggest a retail price for the digital content based on an analysis of retail prices associated with similar digital twin resources (i.e., a number of digital twin resources with the highest similarity scores) and/or retail prices associated with digital twin resources associated with similar physical assets. The suggested price may be an average of prices associated with all digital twin resources or some subset of digital twin resources such as those with highest similarity scores or similarity scores exceeding a threshold, matching contextual data, et cetera. The suggested price may be a low price to make the listing more attractive, or may match the price of the most popular digital twin resources on the digital twin content store as measured, for example, by user rating or by number of downloads.

At 212, the digital twin commercialization program 110A, 110B determines whether the user is making the digital content available on the digital twin content store 116. According to one implementation, if the digital twin commercialization program 110A, 110B determines that the user is not making the digital content available on the digital twin content store 116, for example by determining that the user has indicated the intention not to upload the content by interacting with a corresponding graphical user interface element on a prompt or failing to interact with the prompt after a predetermined amount of time (step 212, “NO” branch), the digital twin commercialization program 110A, 110B may continue to step 202 to receive digital content pertaining to a physical asset from a user performing a selected work order. If the digital twin commercialization program 110A, 110B determines that the user is making the digital content available on the digital twin content store 116, for example by determining that the user has indicated the intention to upload the content by interacting with a corresponding graphical user interface element on a prompt (step 212, “YES” branch), the digital twin commercialization program 110A, 110B may continue to step 214 to upload the digital content to the digital twin content store 216.

At 214, the digital twin commercialization program 110A, 110B uploads the digital content to the digital twin content store 116. The digital twin commercialization program 110A, 110B may transmit the digital content to the digital twin content store 116. In some embodiments, the digital twin commercialization program 110A, 110B may generate a listing associated with the digital content, and may transmit the digital content along with the listing; the digital twin commercialization program 110A, 110B may populate the listing with details regarding the physical asset taken from the work order and/or the contextual data. The digital twin commercialization program 110A, 110B may suggest to the user a title for the listing based, for example, on the asset type, content details, and work order details. The digital twin commercialization program 110A, 110B may user placeholder imagery pulled from the work order within the asset management program 108; in some embodiments, for instance where no image is available, digital twin commercialization program 110A, 110B may prompt the user to capture a new image with sensor 118. The uploaded digital content may be associated with the physical asset within the digital content store 116 and made available to other organizations to view and purchase.

Referring now to FIG. 3, a graphical user interface 300 associated with the digital twin commercialization process 200 is depicted according to at least one embodiment. In an exemplary use case of an embodiment of the invention, Eli is a technician who works for an underground mining company. He heads out to a job site to perform a work order. When he pulls up his asset management program 108 he'll see a list of all the work orders he's assigned to. Work order 5 is for repairing a broken-down car. When Eli examines the car and starts the engine, he hears some unusual clicking sounds. He decides to record some audio of the issue with the audio sensor 118 on his mobile device 102 and associates it with the work order. The digital twin commercialization program 110A, 110B checks the digital twin content store 116 and determines that no audio digital twin resources exist for this asset type. The digital twin commercialization program 110A, 110B recommends to Eli via a popup 308 that there is a lack of audio digital twin content on the digital twin content store 116 and suggests that he make it available for sale on behalf of his organization. It suggests a recommended retail price of $100 with evidence that there are other acoustic models 302 on the exchange for different physical assets and details about those listings and their prices. Eli knows that this is likely to be helpful content to others and decides to publish it on the digital twin content store 116 at the recommended price. He sees a preview 304 wherein digital twin commercialization program 110A, 110B chooses an image 306 of the asset or prompts Eli via a graphical interface element to take a picture with a camera 118 accessible to his mobile device 102 if an image isn't accessible to asset management program 108. The digital twin commercialization program 110A, 110B also suggests a title for the listing 304 based on the content type and work order details, as well as the price point 310 of $100 as suggested in the prompt 308. Eli presses a button within his asset management application 108, such as the LIST button in the prompt 308, to publish.

It may be appreciated that FIGS. 2-3 provide only illustrations of individual implementations and do not imply any limitations with regard to how different embodiments may be implemented. Many modifications to the depicted environments may be made based on design and implementation requirements. For example, in some embodiments of the invention, the digital twin commercialization program 110A, 110B may determine whether there is a gap in a digital twin content store for digital content in real-time or near-real-time as the digital content is received, potentially during execution of the work order, such that the digital twin commercialization program 110A, 110B prompts the user to upload digital content determined to fit a gap within the digital twin resources within a period of several seconds or minutes after the digital content is recorded. In some embodiments, the digital twin commercialization program 110A, 110B may limit the ability to commercialize the digital content to certain classes of users, by, for example, determining the class of user from the work order, and only sending a prompt regarding a commercialization opportunity to lead or senior technicians, or to supervisors.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the asset management program 108 and the digital twin commercialization program 110A in the client computing device 102, and the digital twin commercialization program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the digital twin commercialization program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The asset management program 108 and the digital twin commercialization program 110A in the client computing device 102 and the digital twin commercialization program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the asset management program 108 and the digital twin commercialization program 110A in the client computing device 102 and the digital twin commercialization program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

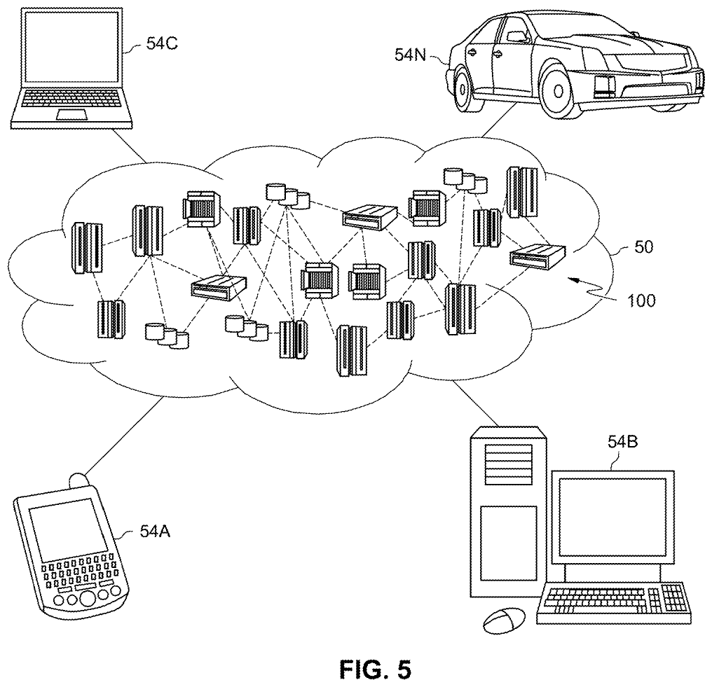

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

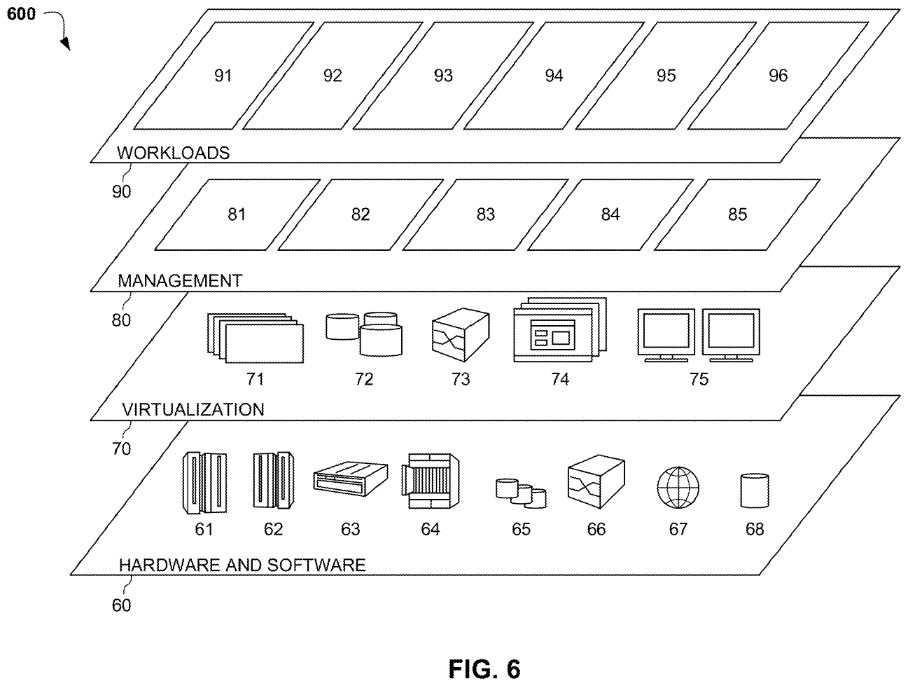

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and digital twin commercialization 96. The digital twin commercialization 96 may enabled to identify commercialization opportunities for digital twin artifacts captured on a mobile device.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for commercializing digital twin content captured by a sensor, the method comprising:
receiving digital content pertaining to a physical asset captured by the sensor; and
responsive to determining that no digital twin resources within a digital twin content store associated with the physical asset exceed a threshold level of similarity to the digital content, uploading the digital content to the digital twin content store based on a user response to one or more prompts.

2. The method of claim 1, further comprising:
responsive to determining that one or more of the digital twin resources within the digital twin content store associated with the physical asset exceed the threshold level of similarity to the digital content, display one or more digital twin resources from the digital content store to the user.

3. The method of claim 1, further comprising: suggesting a price to associate with the digital content within the digital twin content store.

4. The method of claim 1, further comprising: acquiring a plurality of contextual data associated with the digital content based on a work order.

5. The method of claim 1, wherein the digital content comprises sounds or images associated with the physical asset recorded during execution of a work order.

6. The method of claim 1, further comprising: assigning a similarity value with respect to the digital content to one or more digital twin resources associated with the physical asset.

7. The method of claim 1, wherein the digital content comprises a plurality of contextual data comprising a mode of operation of the physical asset at the time the digital content was recorded.

8. A computer system for commercializing digital twin content captured by a sensor, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving digital content pertaining to a physical asset captured by the sensor; and
responsive to determining that no digital twin resources within a digital twin content store associated with the physical asset exceed a threshold level of similarity to the digital content, uploading the digital content to the digital twin content store based on a user response to one or more prompts.

9. The computer system of claim 8, further comprising:
responsive to determining that one or more of the digital twin resources within the digital twin content store associated with the physical asset exceed the threshold level of similarity to the digital content, display one or more digital twin resources from the digital content store to the user.

10. The computer system of claim 8, further comprising: suggesting a price to associate with the digital content within the digital twin content store.

11. The computer system of claim 8, further comprising: acquiring a plurality of contextual data associated with the digital content based on a work order.

12. The computer system of claim 8, wherein the digital content comprises sounds or images associated with the physical asset recorded during execution of a work order.

13. The computer system of claim 8, further comprising: assigning a similarity value with respect to the digital content to one or more digital twin resources associated with the physical asset.

14. The computer system of claim 8, wherein the digital content comprises a plurality of contextual data comprising a mode of operation of the physical asset at the time the digital content was recorded.

15. A computer program product for commercializing digital twin content captured by a sensor, the computer program product comprising:
one or more computer-readable tangible storage medium and program instructions stored on at least one of the one or more tangible storage medium, the program instructions executable by a processor to cause the processor to perform a method comprising:
receiving digital content pertaining to a physical asset captured by the sensor; and
responsive to determining that no digital twin resources within a digital twin content store associated with the physical asset exceed a threshold level of similarity to the digital content, uploading the digital content to the digital twin content store based on a user response to one or more prompts.

16. The computer program product of claim 15, further comprising:
responsive to determining that one or more of the digital twin resources within the digital twin content store associated with the physical asset exceed the threshold level of similarity to the digital content, display one or more digital twin resources from the digital content store to the user.

17. The computer program product of claim 15, further comprising: suggesting a price to associate with the digital content within the digital twin content store.

18. The computer program product of claim 15, further comprising: acquiring a plurality of contextual data associated with the digital content based on a work order.

19. The computer program product of claim 15, wherein the digital content comprises sounds or images associated with the physical asset recorded during execution of a work order.

20. The computer program product of claim 15, further comprising: assigning a similarity value with respect to the digital content to one or more digital twin resources associated with the physical asset.
